(19) United States
(12) Patent Application Publication
(10) Pub. No.: US 2020/0371626 A1
(43) Pub. Date: Nov. 26, 2020

(54) PRESSURE-SENSOR-EMBEDDED DISPLAY

(71) Applicant: Sharp Kabushiki Kaisha, Sakai City, Osaka (JP)

(72) Inventors: Jean MUGIRANEZA, Sakai City (JP); Yasuhiro SUGITA, Sakai City (JP); Shinji YAMAGISHI, Sakai City (JP); Takenori MARUYAMA, Sakai City (JP)

(21) Appl. No.: 16/496,465

(22) PCT Filed: Mar. 27, 2018
(86) PCT No.: PCT/JP2018/012276

§ 371 Date: Sep. 23, 2019

(30) Foreign Application Priority Data
Mar. 29, 2017 (JP) 2017-065356

(51) Int. Cl. G06F 3/041; G06F 3/044; G02F 1/1333

(52) U.S. Cl. CPC G06F 3/0412; G06F 2203/04105; G02F 1/13338; G06F 3/0446

(57) ABSTRACT

To provide a low-cost and compact pressure-sensor-embedded display, in a pressure-sensor-embedded display (1), a touch sensor (5) includes a plurality of touchpad electrodes (7) disposed on a liquid crystal layer (4) side of a circuit board (2), and a pressure sensor (11) includes a plurality of pressure-pad electrodes (12) disposed on the liquid crystal layer (4) side of the circuit board (2) and a plurality of driving electrode bars (13) disposed on the liquid crystal layer (4) side of a counter substrate (3).

### TECHNICAL FIELD

The present invention relates to a pressure-sensor-embedded display including a touch sensor of an electrostatic-capacitance type and a pressure sensor. The touch sensor detects a touch made on a counter substrate facing a circuit board, and the pressure sensor detects pressure applied to the counter substrate.

### BACKGROUND ART

An input device for an electronic system that includes a pressure sensor is known in the related art (refer to PTL 1). The input device includes a first substrate having an input surface. The first substrate has a plurality of sensor electrodes configured to sense input objects in proximity to the input surface. A pair of pressure sensing electrodes are disposed on the bottom side of the first substrate. The input device includes a second substrate. The second substrate has a planar spring plate including a perimeter region surrounding an interior region. The input device includes a spacing layer. The spacing layer is configured to physically couple the interior region of the second substrate to the first substrate. Pressure applied to the input surface deflects the first substrate and the interior region relative to the perimeter region, changing a variable capacitance formed between the pressure sensing electrodes.

### CITATION LIST

### Patent Literature

PTL 1: U.S. Patent Application Publication No. 2014/0002113 (Publication Date: Jun. 2, 2014)

### SUMMARY OF INVENTION

### Technical Problem

A pressure sensor, which is capable of distinguishing between a press touch and a feather touch, reduces operation mistakes that occur for an existing touch panel and can provide a more intuitive, stress-free user interface. Because of this feature, embedding a pressure sensor in a display device has received attention in recent years.

However, embedding a pressure sensor in a display device causes a difficulty of an increase in cost and size of a display device.

A display device known in the related art includes a touch sensor and a pressure sensor separately, which increases the thickness of the display device. In addition, a touch sensor and a pressure sensor each have an associated circuit and controller separately. Consequently, the manufacture and assembly processes become complicated, and the design rule becomes stricter. The cost also increases.

An aspect of the present invention is to provide a low-cost and compact pressure-sensor-embedded display.

### Solution to Problem

To address the above issues, a pressure-sensor-embedded display according to an aspect of the present invention includes a circuit board, a counter substrate disposed so as to face the circuit board, a display layer formed between the circuit board and the counter substrate, a touch sensor of an electrostatic-capacitance type that detects a touch made on the counter substrate, and a pressure sensor that detects pressure applied to the counter substrate. The touch sensor includes a plurality of touchpad electrodes disposed on the display layer side of the circuit board, and the pressure sensor includes a plurality of pressure-pad electrodes disposed on the display layer side of the circuit board and a plurality of driving electrode bars disposed on the display layer side of the counter substrate.

### Advantageous Effects of Invention

According to an aspect of the present invention, it is possible to realize a low-cost and compact pressure-sensor-embedded display.

### BRIEF DESCRIPTION OF DRAWINGS

FIG. 1(a) is a cross-sectional view depicting a structure of a major portion of a pressure-sensor-embedded display according to a first embodiment, and FIG. 1(b) is a cross-sectional view schematically depicting a structure of the pressure-sensor-embedded display.

FIG. 2(a) is an illustration for describing an operation of a self-capacitance-type touchpad electrode disposed in the pressure-sensor-embedded display, and FIG. 2(b) is a cross-sectional view schematically depicting a structure of a pressure sensor disposed in the pressure-sensor-embedded display.

FIG. 3 is a schematic illustration depicting a structure of a circuit board and a counter substrate disposed in the pressure-sensor-embedded display.

FIG. 4(a) is a timing chart depicting operations of a liquid crystal display unit, a touch sensor, and a pressure sensor disposed in the pressure-sensor-embedded display, and FIG. 4(b) is a timing chart depicting operations of the liquid crystal display unit, the touch sensor, and the pressure sensor during a vertical blanking period.

FIG. 5 is a timing chart for describing synchronization of operations between the touch sensor and the pressure sensor.

FIG. 6 is a timing chart for describing other synchronization of operations between the touch sensor and the pressure sensor.

FIG. 7(a) is a schematic illustration for describing an operation of the pressure sensor, and FIG. 7(b) is a schematic illustration for describing an operation of the touch sensor.

FIG. 8(a) is a top view depicting a structure of a circuit board disposed in a pressure-sensor-embedded display according to a second embodiment, and FIG. 8(b) is a bottom view depicting a structure of a counter substrate disposed in the pressure-sensor-embedded display.

FIG. 9(a) is a top view depicting a structure of a circuit board disposed in a pressure-sensor-embedded display according to a third embodiment, and FIG. 9(b) is a bottom view depicting a structure of a counter substrate disposed in the pressure-sensor-embedded display.

### DESCRIPTION OF EMBODIMENTS

Hereinafter, embodiments of the present invention will be described in detail.

### First Embodiment

### (Structure of Pressure-Sensor-Embedded Display 1)

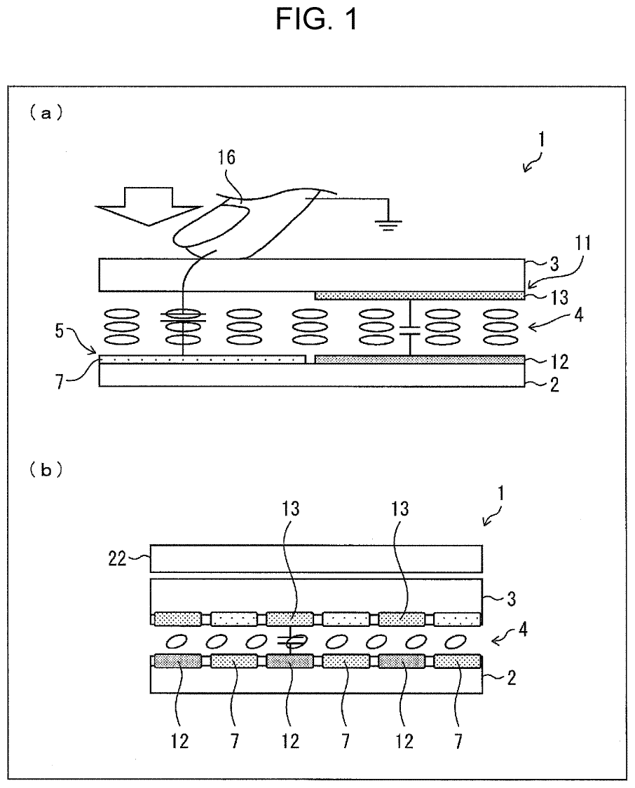

FIG. 1(a) is a cross-sectional view depicting a structure of a major portion of a pressure-sensor-embedded display 1 according to a first embodiment, and FIG. 1(b) is a cross-sectional view schematically depicting a structure of the pressure-sensor-embedded display 1.

The pressure-sensor-embedded display 1 includes a circuit board 2, a counter substrate 3 disposed so as to face the circuit board 2, a liquid crystal layer 4 (display layer) formed between the circuit board 2 and the counter substrate 3. A cover glass 22 is formed on the other side of the counter substrate 3 from the liquid crystal layer 4.

The pressure-sensor-embedded display 1 includes a touch sensor 5 of an electrostatic-capacitance type and a pressure sensor 11. The touch sensor 5 detects a touch made on the counter substrate 3, and the pressure sensor 11 detects pressure applied to the counter substrate 3. The touch sensor 5 includes a plurality of touchpad electrodes 7 disposed on the liquid crystal layer 4 side of the circuit board 2. The pressure sensor 11 includes a plurality of pressure-pad electrodes 12 (common electrodes) disposed on the liquid crystal layer 4 side of the circuit board 2 and a plurality of driving electrode bars 13 disposed on the liquid crystal layer 4 side of the counter substrate 3.

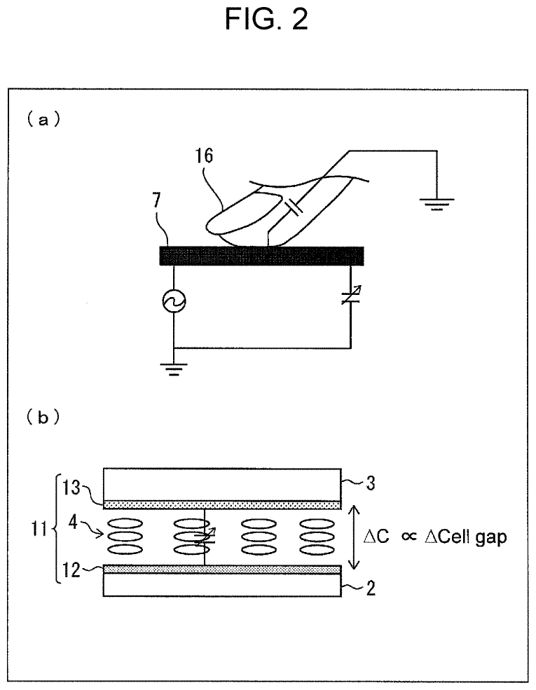

FIG. 2(a) is an illustration for describing an operation of the touchpad electrode 7 of the touch sensor 5 of a self-capacitance type, the touch sensor 5 being disposed in the pressure-sensor-embedded display, and FIG. 2(b) is a cross-sectional view schematically depicting a structure of the pressure sensor 11 disposed in the pressure-sensor-embedded display 1. As depicted in FIG. 2(a), the touchpad electrode 7 is a self-capacitance-type electrode disposed so as to detect capacitance or a change in capacitance between a finger 16, which is to be detected, and the touchpad electrode 7. As depicted in FIG. 2(b), the pressure sensor 11 detects a change in capacitance between the pressure-pad electrode 12 and the driving electrode bar 13, and the change in capacitance is caused by a change in a cell gap of the liquid crystal layer 4 between the circuit board 2 and the counter substrate 3.

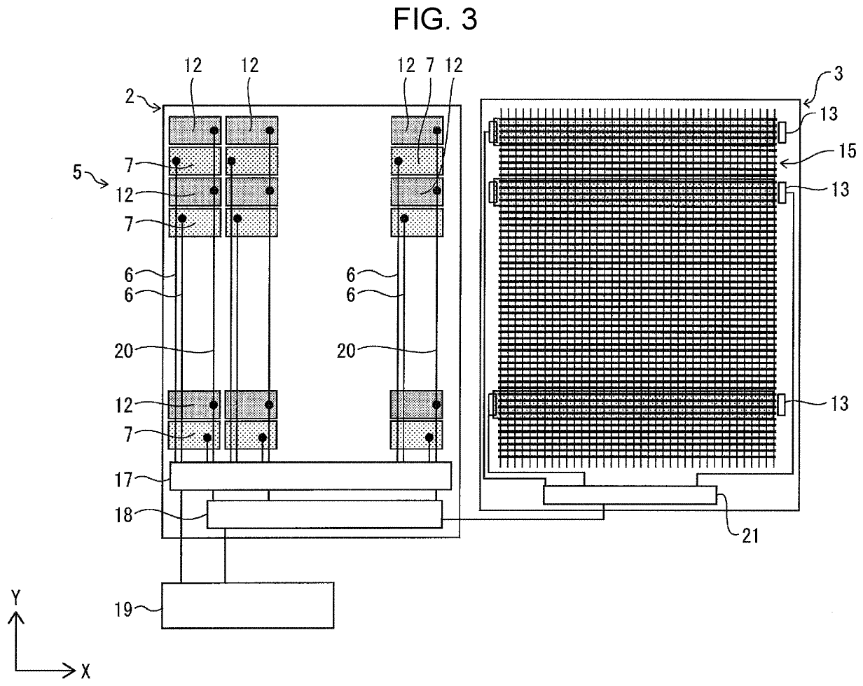

FIG. 3 is a schematic illustration depicting a structure of the circuit board 2 and the counter substrate 3 disposed in the pressure-sensor-embedded display 1. The plurality of touchpad electrodes 7 and the plurality of pressure-pad electrodes 12 are arranged in a matrix on the circuit board 2. In the example depicted in FIG. 3, the plurality of pressure-pad electrodes 12 are placed in odd-numbered rows, and the plurality of touchpad electrodes 7 are placed in even-numbered rows. Needless to say, conversely, the plurality of touchpad electrodes 7 may be placed in odd-numbered rows, and the plurality of pressure-pad electrodes 12 may be placed in even-numbered rows.

The pressure-pad electrodes 12 each also serve as a common electrode for generating an electric field that controls orientations of liquid crystal molecules contained in the liquid crystal layer 4. In addition, the touchpad electrodes 7 each also serve as a common electrode.

The touch sensor 5 includes a plurality of sense lines 6, each of which corresponds to one of the touchpad electrodes 7 arranged in columns and extends in the column direction (the Y-axis direction).

As described above, the circuit board 2 includes the plurality of common electrodes arranged in a matrix as an electrode array, and the plurality of common electrodes generate an electric field that controls orientations of liquid crystal molecules contained in the liquid crystal layer 4. A portion of the electrode array serves as the touchpad electrodes 7 of a self-capacitance type and detects a change in capacitance caused by a touch. The remaining portion of the electrode array serves as the pressure-pad electrodes 12 of a mutual-capacitance type and detects together with the driving electrode bars 13 a change in capacitance caused by pressure.

The plurality of driving electrode bars 13 are disposed on the counter substrate 3 so as to face the pressure-pad electrodes 12. The counter substrate 3 includes a black matrix 15 forming a grid for partitioning color filter layers that have three colors and that form a periodic array. The plurality of driving electrode bars 13 are formed in or on the black matrix 15. The color filter layers having three colors constitute a color filter.

In this way, the driving electrode bars 13 serving as transmitting electrodes (Tx) for detecting pressure are formed by patterning on the black matrix 15 on the counter substrate 3. The transmitting electrodes are formed by patterning so as to overlap the pressure-pad electrodes 12 serving as receiving electrodes (Rx) disposed on the circuit board 2 for detecting pressure.

The circuit board 2 includes a self-capacitance controller 17 coupled to each of the plurality of touchpad electrodes 7 separately via one of the sense lines 6 and a mutual-capacitance controller 18 coupled to each column of the pressure-pad electrodes 12 separately via a pressure sense line 20. The self-capacitance controller 17 and the mutual-capacitance controller 18 are connected to a timing control circuit 19. The timing control circuit 19 controls timing and synchronization of liquid crystal display, touch detection, and pressure detection. The self-capacitance controller 17 is integrated in a display driver.

The counter substrate 3 includes a mutual-capacitance controller 21 connected to the plurality of driving electrode bars 13. The mutual-capacitance controller 21 is connected to the mutual-capacitance controller 18 on the circuit board 2.

### (Operation of Pressure-Sensor-Embedded Display 1)

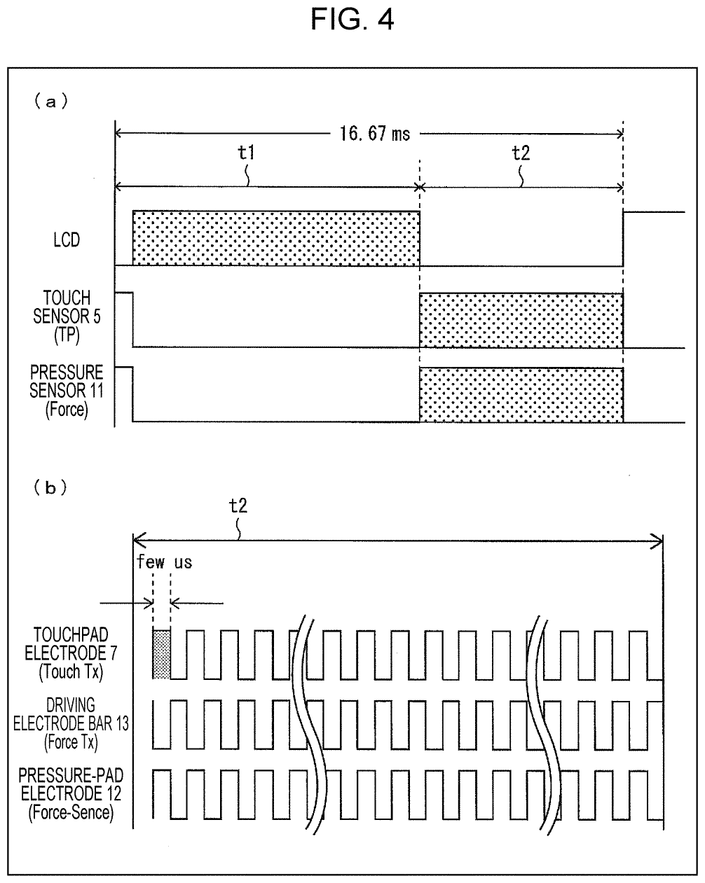

FIG. 4(a) is a timing chart depicting operations of a liquid crystal display unit, the touch sensor 5, and the pressure sensor 11 disposed in the pressure-sensor-embedded display 1, and FIG. 4(b) is a timing chart depicting operations of the liquid crystal display unit, the touch sensor 5, and the pressure sensor 11 during a vertical blanking period.

The touch sensor 5 and the pressure sensor 11 operate in synchronization with vertical scanning by the liquid crystal layer 4 for display. As depicted in FIG. 4(a), the liquid crystal layer 4 (LCD) operates during a display writing period t1 and halts during a vertical blanking period t2 that follows the display writing period t1. The display writing period t1 and the vertical blanking period t2 add up to 16.67 ms (milliseconds). Scanning by the touch sensor 5 and scanning by the pressure sensor 11 are performed during a display refresh period (the vertical blanking period t2) of the liquid crystal layer 4.

Since the touch sensor 5 is a sensor of a self-capacitance type, each of the touchpad electrodes 7 is sequentially charged and discharged. While the touchpad electrodes 7 of the touch sensor 5 of a self-capacitance type are charged, the driving electrode bars 13 serving as the transmitting electrodes (Tx) of the pressure sensor 11 are in an electrically floating condition (floating condition) to avoid an adverse effect on touch detection.

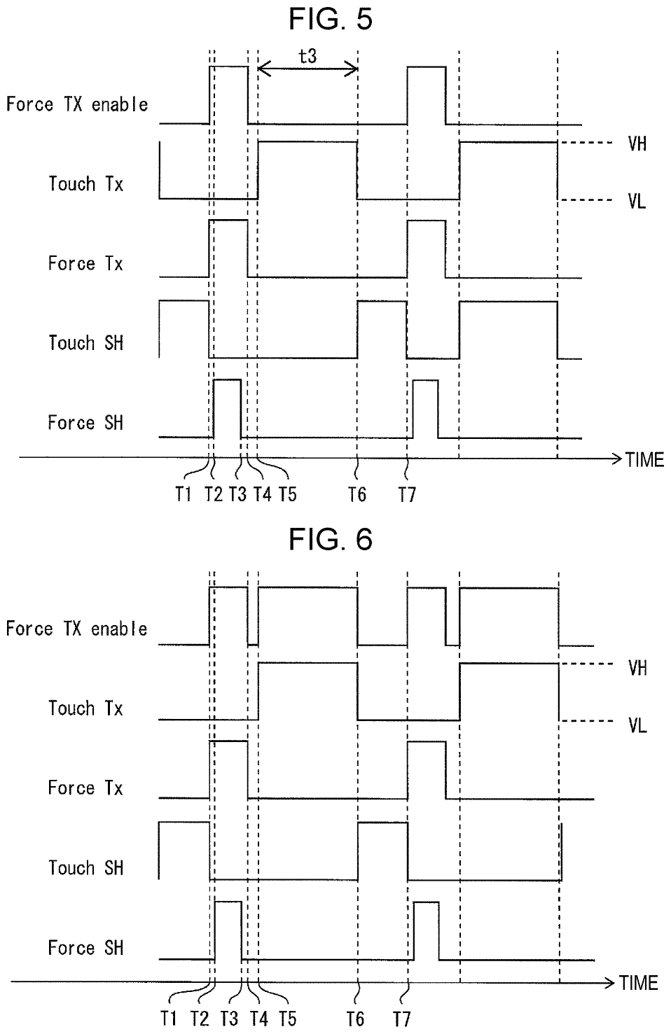

FIG. 5 is a timing chart for describing synchronization of operations between the touch sensor 5 and the pressure sensor 11. First, when a pressure sensor enable signal (Force TX enable) rises from the low state (VL) to the high state (VH) at the time point T1, a transmitting signal (Force Tx) applied to the driving electrode bars 13 serving as the transmitting electrodes (Tx) of the pressure sensor 11 also rises from the low state (VL) to the high state (VH). Then, a read signal (Force SH) that is read from the pressure-pad electrodes 12 serving as the receiving electrodes of the pressure sensor 11 rises from the low state (VL) to the high state (VH) at the time point T2. Next, the read signal (Force SH) falls from the high state (VH) to the low state (VL) at the time point T3. Subsequently, the pressure sensor enable signal (Force TX enable) and the transmitting signal (Force Tx) fall from the high state (VH) to the low state (VL) at the time point T4.

Then, a transmitting signal (Touch Tx) applied to the touchpad electrodes 7 of the touch sensor 5 rises from the low state (VL) to the high state (VH) at the time point T5. Next, when the transmitting signal (Touch Tx) falls from the high state (VH) to the low state (VL) at the time point T6, a read signal (Touch SH) that is read from the touchpad electrodes 7 of the touch sensor 5 rises from the low state (VL) to the high state (VH). Subsequently, the read signal (Touch SH) falls from the high state (VH) to the low state (VL) at the time point T7. Thereafter, the same operation is repeated.

As depicted in FIG. 5, the transmitting signal (Force Tx), which is applied to the driving electrode bars 13 serving as the transmitting electrodes (Tx) of the pressure sensor 11, is in an electrically floating state (floating state) during the sensing period t3 from the time point T5 to the time point T6 while the transmitting signal (Touch Tx), which is applied to the touchpad electrodes 7 of the touch sensor 5, remains in the high state (VH).

FIG. 6 is a timing chart for describing other synchronization of operations between the touch sensor 5 and the pressure sensor 11. The same elements as are described with reference to FIG. 5 are denoted by the same reference symbols. Detailed descriptions of these elements will not be repeated.

When the transmitting signal (Touch Tx), which is applied to the touchpad electrodes 7 of the touch sensor 5, rises from the low state (VL) to the high state (VH) at the time point T5, the pressure sensor enable signal (Force TX enable) also rises from the low state (VL) to the high state (VH). Then, when the transmitting signal (Touch Tx) falls from the high state (VH) to the low state (VL) at the time point T6, the pressure sensor enable signal (Force TX enable) also falls from the high state (VH) to the low state (VL). In this way, the transmitting signal (Touch Tx) is driven by the pressure sensor enable signal (Force TX enable), which is applied to reduce a parasitic capacitance on the electrodes of the touch sensor 5 and resembles a touch sensing signal.

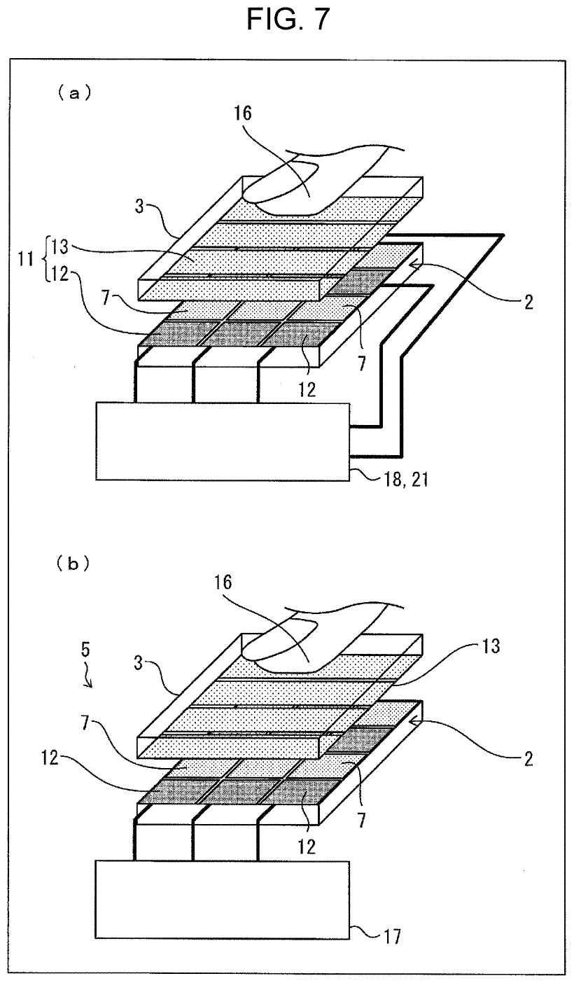

FIG. 7(a) is a schematic illustration for describing an operation of the pressure sensor 11, and FIG. 7(b) is a schematic illustration for describing an operation of the touch sensor 5. Pressure sensing and touch sensing are consecutively performed for efficient use of the sensing period. While a charge period and a discharge period need to be set up in a self-capacitance method, the sensing period need not be divided into a charge period and a discharge period in a mutual-capacitance method. Pressure can be detected while a signal is read from the touchpad electrodes 7 of the touch sensor 5. Applying an appropriate method for reducing a parasitic capacitance on the touchpad electrodes 7 of the touch sensor 5 can shorten the period during which the transmitting signal (Touch Tx) is applied to the touchpad electrodes 7 and extend the period during which the read signal (Touch SH) is read from the touchpad electrodes 7 and the read signal (Force SH) is read from the pressure-pad electrodes 12.

As depicted in FIG. 7(a), all the pressure-pad electrodes 12 on the circuit board 2 are connected to the mutual-capacitance controller 18 during the pressure sensing. Then, a signal from the pressure-pad electrodes 12 serving as the receiving electrodes of the pressure sensor 11 is measured, and the pressure on the touch panel is determined.

As depicted in FIG. 7(b), the driving electrode bars 13 of the pressure sensor 11 are in an electrically floating condition (floating condition) during the touch sensing. To reduce a load capacitance on the touchpad electrodes 7 and improve performance, the pressure-pad electrodes 12 of the pressure sensor 11 are coupled to a signal resembling the signal applied to the touchpad electrodes 7.

### Second Embodiment

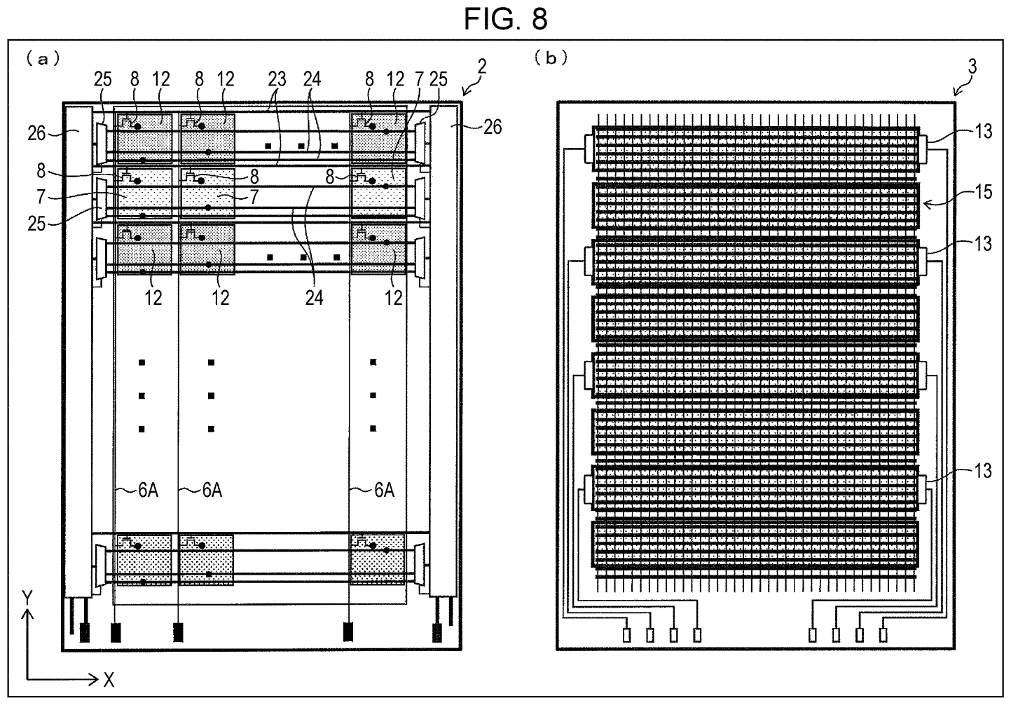

Another embodiment of the present invention will be described in the following with reference to FIG. 8. For the sake of convenience, components having functions that are the same as or similar to the functions of the components described in the above embodiment are denoted by the same numerals or symbols and are not described herein. The embodiment that follows the present embodiment will be described similarly.

FIG. 8(a) is a top view depicting a structure of a circuit board 2 disposed in a pressure-sensor-embedded display according to a second embodiment, and FIG. 8(b) is a bottom view depicting a structure of a counter substrate 3 disposed in the pressure-sensor-embedded display.

A plurality of sense lines 6A are formed on the circuit board 2, and each of the plurality of sense lines 6A corresponds to a column of the touchpad electrodes 7 and the pressure-pad electrodes 12, both of which are arranged in columns, and extends in the Y direction (column direction). A plurality of switch elements 8 (first switch elements) are formed on the circuit board 2, and each of the plurality of switch elements 8 is formed between one of the sense lines 6A and one of the touchpad electrodes 7 or between one of the sense lines 6A and one of the pressure-pad electrodes 12.

The circuit board 2 includes a plurality of multiplexers 25. Each of the plurality of pressure-pad electrodes 12 arranged in rows and each of the plurality of touchpad electrodes 7 arranged in rows are individually connected via a driving line 24 to one of the multiplexers 25. Each of the multiplexers 25 is connected to a scanning circuit 26. Selecting lines 23 extending in the X direction are connected to the scanning circuit 26 to control the plurality of switch elements 8.

First, when the transmitting signal (Touch Tx) is applied to the driving electrode bars 13, the switch elements 8 for the pressure-pad electrodes 12 are set to on state by the scanning circuit 26 via the selecting lines 23, and the read signals (Force SH) are read from the pressure-pad electrodes 12 via the switch elements 8 and the sense lines 6A. Then, the transmitting signal (Touch Tx) is applied to the touchpad electrodes 7 by the scanning circuit 26 via the driving lines 24 and the multiplexers 25. Next, the switch elements 8 for the touchpad electrodes 7 are set to on state by the scanning circuit 26 via the selecting lines 23, and the read signals (Touch SH) are read from the touchpad electrodes 7 via the switch elements 8 and the sense lines 6A.

### Third Embodiment

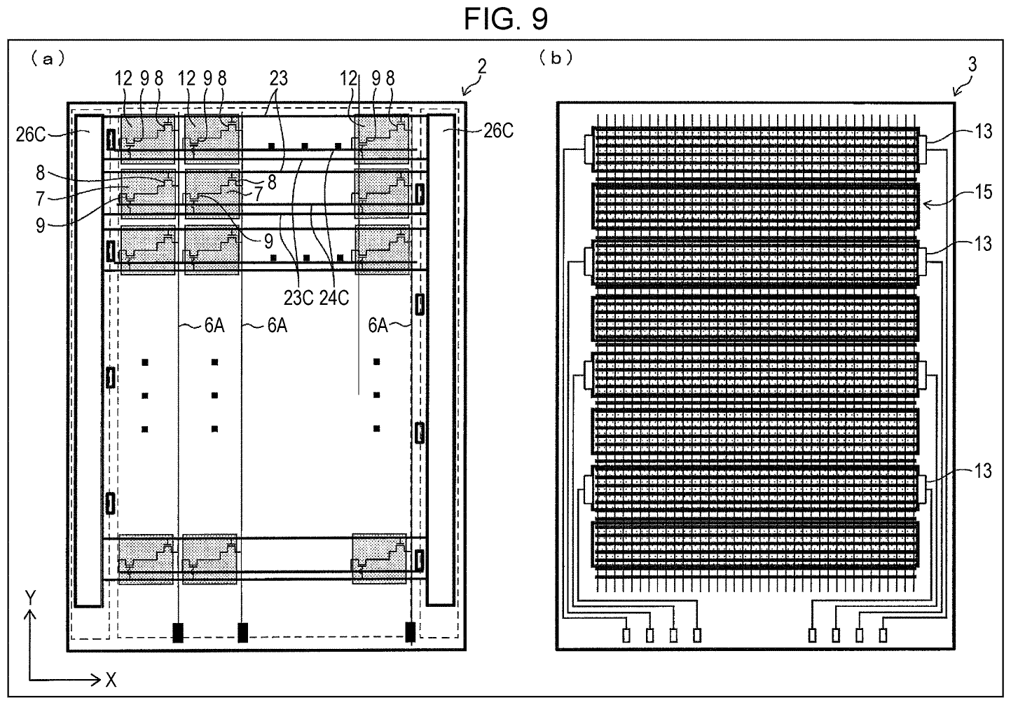

FIG. 9(a) is a top view depicting a structure of a circuit board 2 disposed in a pressure-sensor-embedded display according to a third embodiment, and FIG. 9(b) is a bottom view depicting a structure of a counter substrate 3 disposed in the pressure-sensor-embedded display.

Each pressure-pad electrode 12 includes two switch elements, which are a switch element 8 and a switch element 9 (a first switch element and a second switch element). The switch element 8 is connected to a sense line 6A extending in the Y direction and controlled by a scanning circuit 26C via a selecting line 23 extending in the X direction.

The switch element 9 is connected to a driving line 24C extending in the X direction and controlled by the scanning circuit 26C via a selecting line 23C extending in the X direction.

### SUMMARY

A pressure-sensor-embedded display 1 according to a first aspect of the present invention includes a circuit board 2, a counter substrate 3 disposed so as to face the circuit board 2, a display layer (liquid crystal layer 4) formed between the circuit board 2 and the counter substrate 3, a touch sensor 5 of an electrostatic-capacitance type that detects a touch made on the counter substrate 3, and a pressure sensor 11 that detects pressure applied to the counter substrate 3. The touch sensor 5 includes a plurality of touchpad electrodes 7 disposed on the display layer (liquid crystal layer 4) side of the circuit board 2, and the pressure sensor 11 includes a plurality of pressure-pad electrodes 12 disposed on the display layer (liquid crystal layer 4) side of the circuit board 2 and a plurality of driving electrode bars 13 disposed on the display layer (liquid crystal layer 4) side of the counter substrate 3.

According to the above structure, touchpad electrodes of a touch sensor are disposed on the display layer side of a circuit board. Pressure-pad electrodes of a pressure sensor are disposed on the display layer side of the circuit board, and driving electrode bars of the pressure sensor are disposed on the display layer side of a counter substrate. Thus, the pressure sensor and the touch sensor are embedded in a display. Consequently, a low-cost and compact pressure-sensor-embedded display is provided.

In the pressure-sensor-embedded display 1 according to a second aspect of the present invention, the plurality of touchpad electrodes 7 and the plurality of pressure-pad electrodes 12 in the first aspect may be arranged in a matrix. The plurality of touchpad electrodes 7 may be placed in odd-numbered rows, and the plurality of pressure-pad electrodes 12 may be placed in even-numbered rows.

According to the above structure, touchpad electrodes and pressure-pad electrodes can be formed simultaneously in a single manufacture process.

In the pressure-sensor-embedded display 1 according to a third aspect of the present invention, the plurality of driving electrode bars 13 in the second aspect may be disposed so as to face the pressure-pad electrodes 12 placed in even-numbered rows.

According to the above structure, driving electrode bars and pressure-pad electrodes can constitute a pressure sensor of a mutual-capacitance type.

In the pressure-sensor-embedded display 1 according to a fourth aspect of the present invention, in any one of the first to third aspects, the display layer is a liquid crystal layer 4, and the pressure-pad electrodes 12 each also serve as a common electrode for generating an electric field that controls orientations of liquid crystal molecules contained in the liquid crystal layer 4.

According to the above structure, since a pressure-pad electrode also serves as a common electrode, a pressure-sensor-embedded display whose cost and size are reduced is provided.

In the pressure-sensor-embedded display 1 according to a fifth aspect of the present invention, the counter substrate 3 in any one of the first to fourth aspects may include a color filter and a black matrix 15. The color filter is constituted by periodically arranged color filter layers having three colors, the black matrix 15 forms a grid for partitioning the color filter layers having three colors, and the plurality of driving electrode bars 13 may be formed in or on the black matrix 15.

According to the above structure, since driving electrode bars of a pressure sensor are formed in or on a black matrix forming a grid for partitioning color filter layers having three colors, a more compact pressure-sensor-embedded display is provided.

In the pressure-sensor-embedded display 1 according to a sixth aspect of the present invention, the touch sensor 5 in any one of the second to fifth aspects may further include a plurality of sense lines 6 or 6A and a plurality of first switch elements (switch elements 8). Each of the plurality of sense lines 6 or 6A corresponds to a column of the touchpad electrodes 7 arranged in columns and extends in the column direction. Each of the plurality of first switch elements is formed between one of the sense lines 6 or 6A and one of the touchpad electrodes 7.

According to the above structure, since the first switch elements that are provided enable a read signal to be read by using a single sense line from a column of touchpad electrodes arranged in columns, a more compact pressure-sensor-embedded display is provided.

In the pressure-sensor-embedded display 1 according to a seventh aspect of the present invention, the touch sensor 5 in any one of the second to sixth aspects may further include a plurality of driving lines 24C and a plurality of second switch elements (switch elements 9). Each of the plurality of driving lines 24C corresponds to a row of the touchpad electrodes 7 arranged in rows and extends in the row direction. Each of the plurality of second switch elements is formed between one of the driving lines 24C and one of the touchpad electrodes 7.

According to the above structure, since the second switch elements that are provided enable a transmitting signal to be applied by using a single driving line to a row of touchpad electrodes arranged in rows, a more compact pressure-sensor-embedded display is provided.

The present invention is not limited to the embodiments described above, and various modifications are possible within the scope defined in the claims. An embodiment obtained by appropriately combining technical methods disclosed in each of the embodiments is also within the technical scope of the present invention. Further, combining technical methods disclosed in each of the embodiments can produce a new technical feature.

### REFERENCE SIGNS LIST

1 pressure-sensor-embedded display

2 circuit board

3 counter substrate

4 liquid crystal layer (display layer)

5 touch sensor

6 sense line

7 touchpad electrode

8 switch element (first switch element)

9 switch element (second switch element)

11 pressure sensor

12 pressure-pad electrode (common electrode)

13 driving electrode bar

15 black matrix

24 driving line

1. A pressure-sensor-embedded display comprising:
a circuit board;
a counter substrate disposed so as to face the circuit board;
a display layer formed between the circuit board and the counter substrate;
a touch sensor of an electrostatic-capacitance type that detects a touch made on the counter substrate; and
a pressure sensor that detects pressure applied to the counter substrate,
the touch sensor including a plurality of touchpad electrodes disposed on the display layer side of the circuit board, and
the pressure sensor including a plurality of pressure-pad electrodes disposed on the display layer side of the circuit board and a plurality of driving electrode bars disposed on the display layer side of the counter substrate.

2. The pressure-sensor-embedded display according to claim 1,
wherein the plurality of touchpad electrodes and the plurality of pressure-pad electrodes are arranged in a matrix,
the plurality of touchpad electrodes are placed in odd-numbered rows, and
the plurality of pressure-pad electrodes are placed in even-numbered rows.

3. The pressure-sensor-embedded display according to claim 2,
wherein the plurality of driving electrode bars are disposed so as to face the pressure-pad electrodes placed in even-numbered rows.

4. The pressure-sensor-embedded display according to claim 1,
wherein the display layer is a liquid crystal layer, and
the pressure-pad electrodes each also serve as a common electrode for generating an electric field that controls orientations of liquid crystal molecules contained in the liquid crystal layer.

5. The pressure-sensor-embedded display according to claim 1,
wherein the counter substrate includes a color filter and a black matrix, the color filter is constituted by periodically arranged color filter layers having three colors, and the black matrix forms a grid for partitioning the color filter layers having three colors, and
wherein the plurality of driving electrode bars are formed on the black matrix.

6. The pressure-sensor-embedded display according to claim 2,
wherein the touch sensor further includes a plurality of sense lines, each of which corresponds to a column of the plurality of touchpad electrodes arranged in columns and extends in a column direction, and
a plurality of first switch elements, each of which is formed between one of the sense lines and one of the plurality of touchpad electrodes.

7. The pressure-sensor-embedded display according to claim 2,
wherein the touch sensor further includes a plurality of driving lines, each of which corresponds to a row of the plurality of touchpad electrodes arranged in rows and extends in a row direction, and
a plurality of second switch elements, each of which is formed between one of the driving lines and one of the plurality of touchpad electrodes.
